(19) United States
(12) Patent Application Publication
(10) Pub. No.: US 2025/0036579 A1
(43) Pub. Date: Jan. 30, 2025

(54) MEMORY DEVICE WITH MULTIPLE PHYSICAL INTERFACES

(71) Applicant: Micron Technology, Inc., Boise, ID (US)

(72) Inventors: Raymond Chang, Sacramento, CA (US); Raghukiran Sreeramaneni, Frisco, TX (US); Nevil N. Gajera, Meridian, ID (US)

(21) Appl. No.: 18/625,212

(22) Filed: Apr. 3, 2024

Related U.S. Application Data
(60) Provisional application No. 63/528,884, filed on Jul. 25, 2023.

(51) Int. Cl. G06F 13/16; G06F 12/06

(52) U.S. Cl. CPC G06F 13/1668; G06F 12/0646; G06F 2212/1008

(57) ABSTRACT

A memory device (e.g., a high-bandwidth memory (HBM) device) with multiple physical interfaces (PHYs) is disclosed. The memory device includes a base semiconductor die having a first physical interface (PHY) arranged in accordance with a Joint Electron Device Engineering Council (JEDEC) standard and a second PHY arranged differently from the first PHY and electrically disconnected from the first PHY. The base semiconductor die further includes first contacts disposed at a first side of the base semiconductor die and second contacts disposed at a second side of the base semiconductor die opposite the first side. The first contacts and the second contacts couple with a first one of the first PHY and the second PHY. The memory device further includes one or more memory dies coupled with the base semiconductor die through the second contacts.

### CROSS-REFERENCE TO RELATED APPLICATION(S)

The present application claims priority to U.S. Provisional Patent Application No. 63/528,884, filed Jul. 25, 2023, the disclosure of which is incorporated herein by reference in its entirety.

### TECHNICAL FIELD

The present disclosure generally relates to memory devices and, more particularly, relates to a memory device with multiple physical interfaces.

### BACKGROUND

Computer memory stores data to be accessed by a processor. When a processor wishes to access data from memory, an access request is made. In response to the access request, the memory can return the requested data to the processor. The access request can be communicated through a physical interface (PHY) implemented with the processor or the computer memory. The configuration of the PHY and the transmission of the access request or data can be governed by a communication protocol or the configuration of the memory or the processor. To increase the cross compatibility of memory devices, standards committees, such as the Joint Electron Device Engineering Council (JEDEC), have developed various standards that detail certain configuration and communication requirements with which memory devices and processors are to comply.

### BRIEF DESCRIPTION OF THE DRAWINGS

FIG. 1 illustrates an example computing device in which various techniques and devices described herein can be implemented.

FIG. 2 illustrates an example system-in-package (SiP) that includes a memory device in accordance with an embodiment of the present technology.

FIG. 3 illustrates an example memory die in accordance with an embodiment of the present technology.

FIG. 4 illustrates a top view of an example SiP in a first configuration in accordance with an embodiment of the present technology.

FIG. 5 illustrates a top view of an example SiP in a second configuration in accordance with an embodiment of the present technology.

FIG. 6 illustrates an example method for fabricating a semiconductor device in accordance with an embodiment of the present technology.

### DETAILED DESCRIPTION

The continuously growing gap between processor and memory speeds is an important drawback in overall computer performance. To improve communication speed and increase compatibility across memory devices, standards committees, such as JEDEC, have created standards that govern the arrangement of memory devices and the way with which memory devices are communicated. While these standards can increase compatibility, these standards often exclude the ability to alter designs for application-specific improvements. Nonetheless, some applications can greatly benefit from these application-specific improvements. One such example is artificial intelligence (AI) and machine learning (ML) applications where communication speed is paramount. In these cases, designers may choose to implement additional or alternative features within the memory device that do not comport to the JEDEC standard. While these design-specific improvements can be crucial for the intended application, they can make these products unusable for other applications or for different customers, which can complicate product development by increasing the total number of products that must be developed.

To address these issues and others, embodiments of the present technology provide a configurable memory device that can be configured into a standard-compliant (e.g., JEDEC-compliant) configuration and a custom configuration. In doing so, designers can develop a lesser number of total products by enabling custom products designed for certain applications or customers to be reconfigured into the standard-compliant and widely utilized configuration, thereby streamlining product development. The memory device can include a base semiconductor die having a first PHY arranged in accordance with a JEDEC standard and a second PHY arranged differently from the first PHY and electrically disconnected from the first PHY. One of the first or second PHY can be connected to contacts coupled with a host device and contacts coupled with one or more memory dies. In this way, the configuration of the memory device can be assigned (e.g., after product development) to enable a custom application or a standard-compliant application.

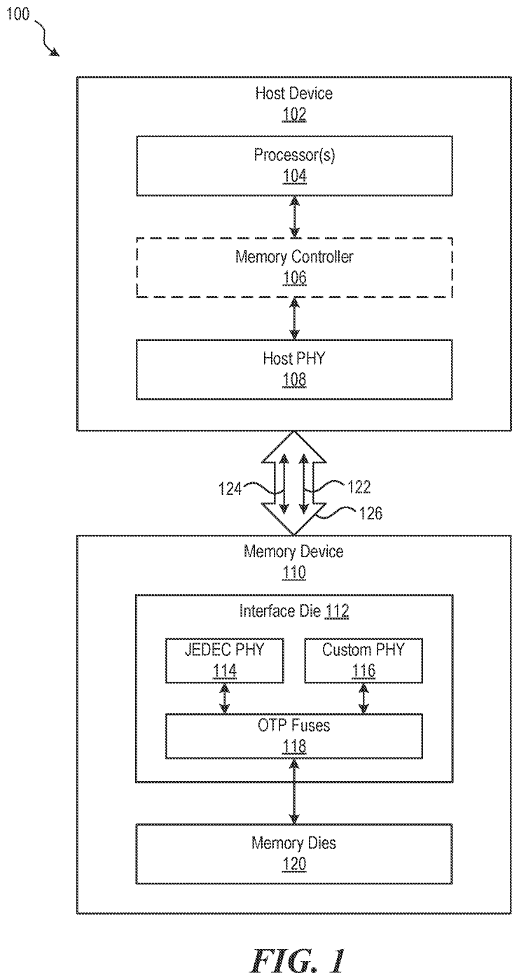

FIG. 1 illustrates an example computing device 100 in which various techniques and devices described herein can be implemented. The computing device 100 includes a host device 102 and a memory device 110. The host device 102 can include at least one processor 104, a memory controller 106, and a host PHY 108. The processor 104 can include the computing device's host processor, central processing unit (CPU), graphics processing unit (GPU), AI processor (e.g., a neural-network/AI accelerator), or other hardware processor or processing unit. The memory controller 106 can control the transmission of commands to the memory device 110. For example, the memory controller 106 can be responsible for addressing commands to correct portions of the memory device 110 or scheduling the sending of the commands. The host PHY 108 can be responsible for communicating signals between the host device 102 and the memory device 110.

The computing device 100 further includes the memory device 110 (e.g., a high-bandwidth memory (HBM) device), which includes an interface die 112 and one or more memory dies 120 coupled with the interface die 112. The interface die 112 includes a JEDEC PHY 114 implemented in accordance with a JEDEC standard (e.g., a JEDEC double data rate (DDR) standard, such as the DDR3, DDR4, DDR5, or other generation of the DDR standard, a JEDEC HBM standard, such as HBM2, HBM3, or other generation of the HBM standard, or any other JEDEC standard) and a custom PHY 116 implemented in a different configuration than the JEDEC PHY 114. The JEDEC PHY 114 can be responsible for the communication of signaling between the host device 102 and the memory dies 120 in accordance with a JEDEC standard. The JEDEC PHY 114 can provide various input/output (I/O) functionality between the memory controller 106 and the memory dies 120. For instance, the JEDEC PHY 114 can provide clock and power management. The JEDEC PHY 114 can issue strobe signaling on appropriate channels or buses to enable reads, writes, or other operations in the memory dies 120 in response to commands from the memory controller 106. The JEDEC PHY 114 can issue the signaling on certain channels and buses based on the allocation of channels to particular memory locations in accordance with a JEDEC standard. The JEDEC PHY 114 can similarly ensure proper timing and delay between subsequent commands based on the requirements of the JEDEC standard. In aspects, the JEDEC PHY 114 can include I/O pads, phase lock loop (PLL) circuitry, connective circuitry to implement transmit and receive paths, control logic, and power distribution and electrostatic discharge protection circuitry.

In contrast, the custom PHY 116 could be configured to perform alternative or additional functions that are not described in the JEDEC standard. In this way, the custom PHY 116 can be adjusted to suit individual applications. For instance, the custom PHY 116 can transmit signaling on various buses in accordance with an arrangement of memory that does not comply with a JEDEC standard. Similarly, the custom PHY 116 can transmit signaling without adhering to the timing constraints required by a JEDEC standard. In some implementations, additional logic (e.g., a memory controller, processing in memory (PIM) logic, an AI accelerator) can be implemented on the memory device 110.

To accommodate this additional logic implemented at the memory device 110, the custom PHY 116 can be configured to accommodate communication of signals to/from the additionally implemented logic. For example, when a memory controller is implemented on the memory device 110, the custom PHY 116 can receive commands that are not yet addressed or scheduled and provide the commands to the additional logic that implements the memory controller. The memory controller can determine the location at which the requested data is/will be stored and schedule and properly address a command (e.g., a read or write command) to the memory location.

In some embodiments, PIM can be implemented in the additional logic supported through the custom PHY 116. For example, some arithmetic can be performed in the memory device 110 instead of returning the data to the host device 102 to be processed. In doing so, data transfers between the host device 102 and the memory device 110 can be reduced, and with them, the penalties incurred by memory accesses. Given that some arithmetic can be performed in the memory without output from the memory device 110, the custom PHY 116 may not return data in response to every access request. Instead, the custom PHY 116 can return data to the host device 102 only when the increased capabilities of the processor 104 are needed to perform the processing. In some cases, the custom PHY 116 can receive signaling that indicates when an operation is to be performed through PIM. Alternatively or additionally, the custom PHY 116 or the additional logic can determine when a requested operation can be performed in memory. In these cases, the operation can be performed in the memory device 110, and the custom PHY 116 may not return the data to the host device 102 until it has been processed.

As a specific example, the additional logic can implement an AI accelerator. AI accelerators are a class of specialized hardware accelerators designed to accelerate AI and ML applications (e.g., an application-specific integrated circuit (ASIC)). In aspects, the AI accelerator can perform low-precision arithmetic or other PIM operations. In some cases, the AI accelerator can alter the scheduling of commands to improve efficiency. Functionality can be provided through hardware, such as transistors. The custom PHY 116 can provide different 1/O functionality to the AI accelerator. For example, the custom PHY 116 can receive signaling indicating when the AI accelerator should be activated. In other cases, the AI accelerator can be activated when the AI accelerator determines that computation speed can be improved by processing data using the AI accelerator. Given that some operations can be performed using the AI accelerator, the custom PHY 116 can output data from the memory device 110 only after the data has been processed by the AI accelerator.

As illustrated, the memory device 110 includes one or more memory dies 120 coupled with the interface die 112. The memory dies 120 can include any type of memory, such as integrated circuit memory, dynamic memory, random access memory (RAM) (e.g., dynamic RAM (DRAM) or static RAM (SRAM)), or Flash memory, to name just a few. The memory dies 120 can further include any amount of memory (e.g., 8 GB, 16 GB, 32 GB, or 64 GB). In aspects, the memory dies 120 include volatile memory. The memory dies 120 can include memory of a single type or memory of multiple types. In general, the memory dies 120 can be implemented as any addressable memory having identifiable locations of physical storage.

The memory device 110 can be programmed into different configurations such that the JEDEC PHY 114 or the custom PHY 116 can operate as the PHY for the memory device 110. For example, one-time programmable (OTP) fuses 118 can connect the JEDEC PHY 114 or the custom PHY 116 to the memory dies 120 through connective circuitry (e.g., traces, lines, vias, through-silicon vias (TSVs)). Specifically, a first set of the fuses 118 can couple the JEDEC PHY 114 and circuitry that couples with the memory dies 120, and a second set of the fuses 118 can couple the custom PHY 116 and the circuitry that couples with the memory dies 120. In one configuration, the second set of fuses 118 can be burned to disconnect the custom PHY 116, while leaving the first set of fuses 118 intact. In doing so, the JEDEC PHY 114 can be used to communicate signaling between the host device 102 and the memory dies 120. In another configuration, the first set of fuses 118 can be burned to disconnect the JEDEC PHY 114, while leaving the second set of fuses 118 intact. In doing so, the custom PHY 116 can be used to communicate signaling between the host device 102 and the memory dies 120.

The computing device 100 further includes an interconnect 126. The computing device 100 can be any type of computing device, computing equipment, computing system, or electronic device, for example, hand-held devices (e.g., mobile phones, tablets, digital readers, and digital audio players), computers, vehicles, or appliances. Components of the computing device 100 may be housed in a single unit or distributed over multiple, interconnected units (e.g., through wired or wireless interconnects). In aspects, the host device 102 and the memory device 110 are discrete components mounted to and electrically coupled through an interposer, printed circuit board (PCB), or other organic or inorganic substrate (e.g., implementing a portion of the interconnect 126).

As shown, the host device 102 and the memory device 110 are coupled with one another through the interconnect 126. The processor 104 executes instructions that cause the memory controller 106 of the host device 102 to send signals on the interconnect 126 that control operations at the memory device 110. The memory device 110 can similarly communicate data to the host device 102 over the interconnect 126. The interconnect 126 can include one or more command-address (CA) buses 122 and one or more data (DQ) buses 124. The CA buses 122 can communicate control signaling indicative of commands to be performed at select locations (e.g., addresses) of the memory device 110. The DQ buses 124 can communicate data between the host device 102 and the memory device 110. For example, the DQ buses 124 can be used to communicate data to be stored in the memory device 110 in accordance with a write request, data retrieved from the memory device 110 in accordance with a read request, or an acknowledgment returned from the memory device 110 in response to successfully performing operations (e.g., a write operation) at the memory device 110. The CA buses 122 can be realized using a group of wires, vias, or other circuit components, and the DQ buses 124 can encompass a different group of wires, vias, or other circuit components of the interconnect 126. As some examples, the interconnect 126 can include a front-side bus, a memory bus, an internal bus, a peripheral component interconnect (PCI) bus, etc. In aspects, the interconnect 126 can include a single data rate (SDR) or DDR bus.

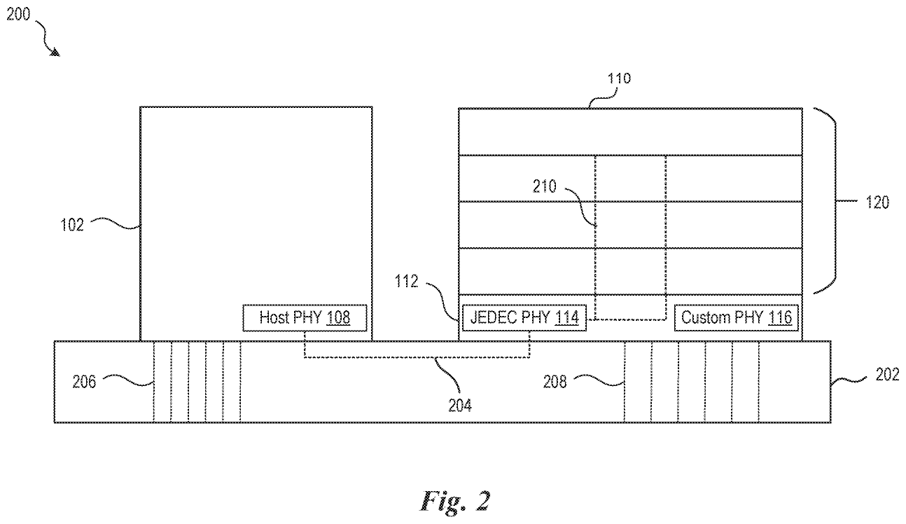

FIG. 2 illustrates an example system-in-package (SiP) 200 that includes a memory device 110 in accordance with an embodiment of the present technology. As illustrated in FIG. 2, the SiP 200 includes a base substrate 202 (e.g., a silicon interposer, a PCB, an organic or inorganic substrate, or the like), as well as a host device 102 (e.g., a CPU or GPU) and the memory device 110 each integrated at an upper surface of the base substrate 202. In the illustrated embodiments, the host device 102 and associated components (e.g., the register, L1 cache, and the like) are illustrated as a single package, and the memory device 110 includes a stack of semiconductor dies. The stack of semiconductor dies in the memory device 110 includes an interface die 112 and one or more memory dies 120. The interface die 112 includes the JEDEC PHY 114 and the custom PHY 116.

The host device 102 is coupled to the memory device 110 through a high-bandwidth bus that includes one or more route lines 204 (illustrated schematically as a single line in FIG. 2) formed into (or on) the base substrate 202. In various embodiments, the route lines 204 can include one or more metallization layers formed in one or more redistribution layers (RDLs) of the base substrate 202 and/or one or more vias interconnecting the metallization layers and/or traces. Further, although not illustrated in FIG. 2, it will be understood that the host device 102 and the memory device 110 can each be coupled to the route lines 204 via connective structures (e.g., solder balls), metal-metal bonds, and/or any other suitable conductive bonds. That is, the high-bandwidth bus of the base substrate 202 can couple the host device 102 to the memory device 110 and any buses therein (e.g., an internal bus of the memory device 110, as explained below).

The base substrate 202 can further include route lines 206 and route lines 208 (illustrated schematically as vertical lines in FIG. 2) that couple the host device 102 and the memory device 110, respectively, with external components (e.g., on a package substrate or motherboard) coupled to the base substrate 202 at a side opposite the host device 102 and the memory device 110. Like the route lines 204, the route lines 206 or the route lines 208 can include one or more metallization layers formed in one or more RDLs of the base substrate 202 and/or one or more vias interconnecting the metallization layers and/or traces. Further, although not illustrated in FIG. 2, it will be understood that the host device 102 and the memory device 110 can each be coupled to the route lines 206 and the route lines 208, respectively, via connective structures (e.g., solder balls), metal-metal bonds, and/or any other suitable conductive bonds.

As discussed in more detail below, the internal bus of the memory device 110 can include a plurality of TSVs 210 extending from the interface die 112 to one or more of the memory dies 120. Connective circuitry (traces, lines, vias, or the like) can extend from the JEDEC PHY 114 or the custom PHY 116 to the TSVs 210. In some cases, one or more fuses (e.g., the OTP fuses 118 illustrated in FIG. 1) can connect the JEDEC PHY 114 or the custom PHY 116 to the TSVs 210 to enable the memory device 110 to be configured to support different designs. For example, as illustrated, the custom PHY 116 is disconnected from the TSVs 210 (e.g., by burning the fuses connecting the custom PHY 116 to the TSVs 210) and the JEDEC PHY 114 is connected to the TSVs 210 (e.g., by leaving the fuses connecting the JEDEC PHY 114 and the TSVs 210 intact). In this way, the JEDEC PHY 114 can facilitate communication between the host device 102 and the memory device 110. In some embodiments, the fuses could alternatively be implemented between the route lines 204 and the JEDEC PHY 114 or the custom PHY 116 to configure the memory device 110. In general, however, the PHY connected to the TSVs 210 can communicate signaling to the memory dies 120 through the TSVs 210.

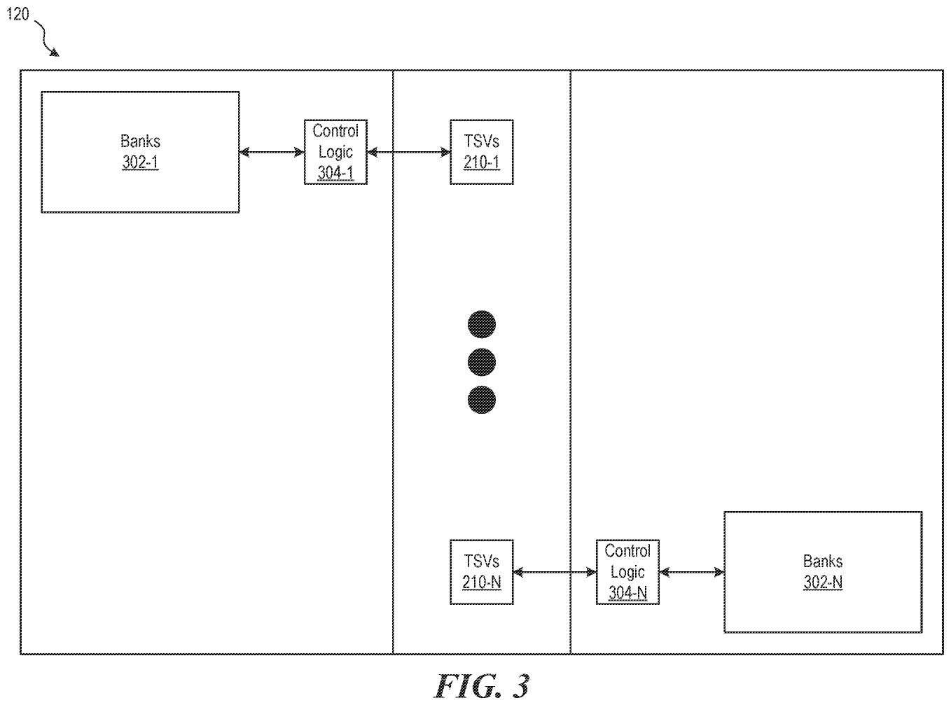

FIG. 3 illustrates an example memory die 120 in accordance with an embodiment of the present technology. The memory die 120 includes memory banks 302 (e.g., memory banks 302-1 through memory banks 302-N). The memory banks 302 couple to the TSVs 210 (e.g., TSVs 210-1 through TSVs 210-N), which can provide a command interface (e.g., a CA bus), a data interface (e.g., DQ buses), or other interfaces. The memory banks 302 can be organized into channels and pseudo channels. Each of the channels can couple with a corresponding CA bus, and each of the pseudo channels can transmit/receive data to/from a corresponding DQ bus. As illustrated, memory banks 302-1 couple with a CA bus and one or more DQ buses implemented in TSVs 210-1, and memory banks 302-N couple with a CA bus and one or more DQ buses implemented in TSVs 210-N.

Control logic 304 (e.g., control logic 304-1 through control logic 304-N) can be implemented for each of the channels between the TSVs 210 and the memory banks 302 to control communication signaling between the memory banks 302 and the TSVs 210. In aspects, the control logic 304 can be used to decode and analyze commands transmitted through the CA bus of the TSVs 210 to initiate the performance of operations (e.g., reads or writes) at the memory banks 302. The control logic 304 can route return data resulting from operations at memory banks 302 to a corresponding DQ bus implemented in the TSVs 210.

The memory die 120 can perform operations in accordance with commands received from a memory controller (e.g., memory controller 106 of FIG. 1). A command from the memory controller to the memory die 120 can be directed to a channel (and the memory banks associated with that channel) and/or to a pseudo channel subdivided from the channel (and the memory banks associated with that pseudo channel) and received over the command interface associated with the channel. For example, the control logic 304 can receive a command to implement a read or write operation at the memory banks 302 through the CA bus implemented within the TSVs 210. The command can include one or more bits (e.g., in a header) that indicate a targeted rank (e.g., a targeted die) and a target pseudo channel or bank to which the command is directed.

Once the command is determined to be directed to the memory die 120, the command on a CA bus associated with the channel can be analyzed to determine which of the memory banks 302 are targeted by the command. The control logic 304 can then forward signaling to targeted banks of the memory banks 302 to perform the desired operation at the targeted row and column. Performing operations at the memory banks 302 can cause data to be returned to the control logic 304 for output to the memory controller. For example, if the operation is a read operation, the return data can include data stored in the targeted row and column of the memory banks 302. Alternatively, if the operation is a write operation or other operation, the data can include an acknowledgment (e.g., a signal indicative of the successful operation or a return of the data that was written) of a successful operation at the targeted row and column of the memory banks 302. Once routed to the associated DQ bus of the TSVs 210, the return data can be transmitted to the memory controller using the associated DQ bus.

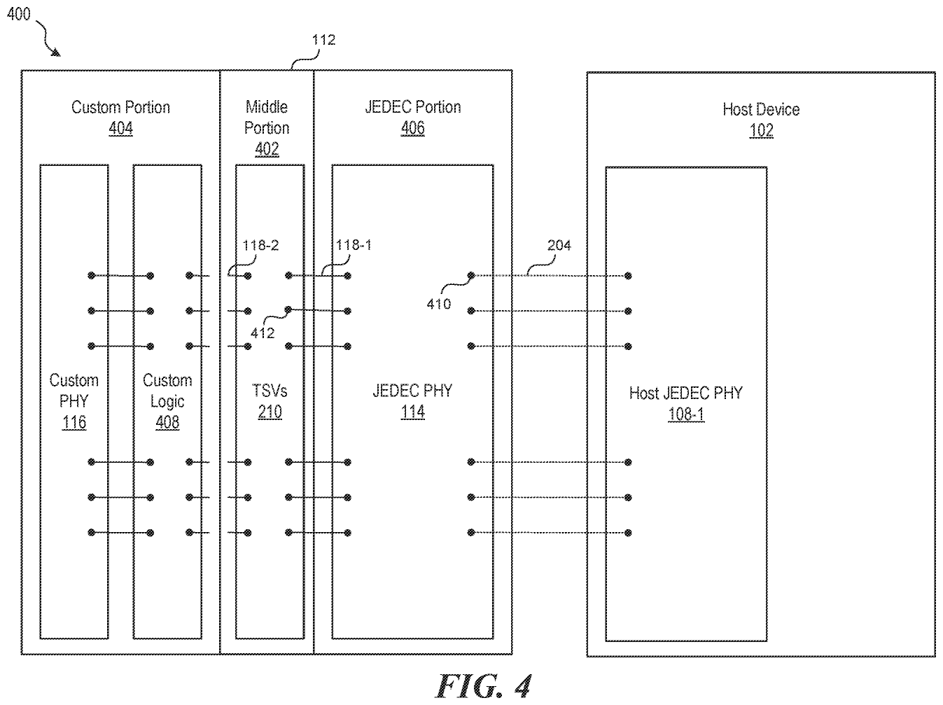

FIG. 4 illustrates a top view of an example SiP 400 in a first configuration in accordance with an embodiment of the present technology. The example SiP 400 includes a host device 102 and a memory device having an interface die 112. The host device 102 includes a host PHY 108-1 (e.g., an example of the host PHY 108 of FIG. 1) implemented in accordance with a JEDEC standard. The memory device includes a middle portion 402 as well as a custom portion 404 and a JEDEC portion 406 implemented on opposite sides of the middle portion 402. The middle portion 402 includes TSVs 210 that couple the interface die 112 to one or more memory dies (e.g., the memory dies 120 of FIG. 1). The custom portion 404 includes the custom PHY 116 and a collection of circuitry that implements custom logic 408 at the interface die 112. For example, the custom logic 408 can implement a memory controller, logical circuitry for performing one or more PIM operations, or an AI accelerator. The JEDEC portion 406 includes the JEDEC PHY 114.

Connective circuitry couples the custom portion 404 and the JEDEC portion 406 to the middle portion 402. For example, the fuses 118 (e.g., fuses 118-1 and fuses 118-2) can couple (e.g., through traces, lines, vias, or other connective circuitry) the JEDEC PHY 114 and the custom PHY 116 to contacts 412 at the middle portion 402 that couple with the TSVs 210. The fuses 118 can be burned to configure the interface die 112 in the JEDEC configuration or the custom configuration. For example, as illustrated, the fuses 118-2 connecting the custom PHY 116 to the TSVs 210 can be burned to disconnect the custom PHY 116 from the TSVs 210, and the fuses 118-1 connecting the JEDEC PHY 114 to the TSVs 210 can be left intact. In this way, signals can be communicated to the TSVs 210 through the JEDEC PHY 114. Although illustrated as being on the interface die 112, in some cases, the TSVs 210 are not implemented on the interface die 112 (e.g., when the interface die 112 is face up). Instead, the contacts 412 can be implemented at the middle portion 402 of the interface die 112 and connect (e.g., through traces, lines, vias, or other connective circuitry) to the TSVs 210 extending through the memory dies (e.g., memory dies 120 of FIG. 2) stacked to the interface die 112.

The route lines 204 can extend from the host device 102 to the memory device at the interface die 112 (e.g., through an interposer, PCB, or other substrate). For example, the route lines 204 can extend from the host PHY 108-1 to the connected one of the JEDEC PHY 114 and the custom PHY 116. Contacts 410 (e.g., contact pads) can be disposed at a bottom side of the interface die 112 (e.g., opposite the side shown in FIG. 4) to connect a connected one of the JEDEC PHY 114 and the custom PHY 116 to the route lines 204. The contacts 410 can couple to the route lines 204 through connective structures (e.g., solder balls). Given that the JEDEC PHY 114 is connected and the custom PHY 116 is disconnected in FIG. 4, the contacts 410 can be implemented at the JEDEC portion 406, and route lines 204 can connect from the host PHY 108-1 to the JEDEC PHY 114 through the contacts 410. The host PHY 108-1 can be configured similarly to the connected one of the JEDEC PHY 114 and the custom PHY 116. Specifically, the connected one of the JEDEC PHY 114 and the custom PHY 116 can be configured to receive specific signals, and the host PHY 108-1 can be configured to transmit that signaling from the host device 102 to the connected one of the JEDEC PHY 114 and the custom PHY 116. Similarly, the connected one of the JEDEC PHY 114 and the custom PHY 116 can be configured to transmit certain signaling to the host device 102, and the host PHY 108-1 can be configured to receive that signaling. Thus, as illustrated, the host PHY 108-1 can be configured in accordance with a JEDEC standard when the JEDEC PHY 114 is the connected PHY and the interface die 112 is in the JEDEC configuration.

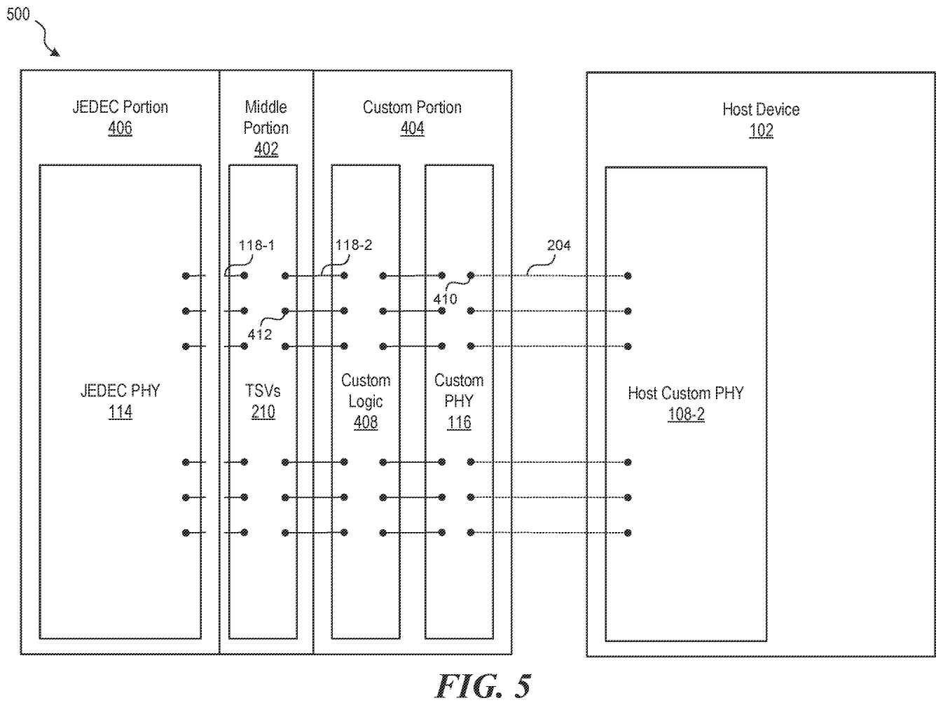

FIG. 5 illustrates a top view of an example SiP 500 in a second configuration in accordance with an embodiment of the present technology. In general, the SiP 500 can be implemented similar to the SiP 400 of FIG. 4 but with a different connected PHY. For example, instead of burning the fuses 118-2, the fuses 118-1 can be burned while leaving the fuses 118-2 intact. In doing so, the custom PHY 116 and the custom logic 408 can remain connected to the TSVs 210 through the contacts 412. The contacts 410 can connect to the custom PHY 116, and the route lines 204 can connect the contacts 410 and the host PHY 108-2 (e.g., an example of the host PHY 108 of FIG. 1). The host device 102 can be configured to match the connected PHY. For example, the host PHY 108-2 can be configured to communicate different signaling to enable alternative or additional features that are provided by the custom PHY 116 or the custom logic 408.

In an example in which the custom logic 408 implements a memory controller, the host PHY 108-2 can transmit commands that have not yet been properly addressed or scheduled. Thus, the custom PHY 116 can receive the commands and provide them to the memory controller in the custom logic 408 for addressing and scheduling. Once addressed and scheduled, signaling (e.g., strobes) can be transmitted through the TSVs 210 to the determined address. Data (e.g., read data, write acknowledgments, and so on) can similarly be returned to the host PHY 108-2 through the custom PHY 116.

In yet another aspect in which the custom logic 408 provides PIM, the host PHY 108-2 can transmit commands to perform one or more processing operations of retrieved data within the memory device using the custom logic 408. As a specific example, the custom logic 408 can implement an AI accelerator, which performs low-precision arithmetic or other PIM operations to increase the speed of AI or ML applications. The custom PHY 116 can be configured to receive the command to perform the processing operations in memory and communicate the command to the custom logic 408 to cause the custom logic 408 to perform the operation on the retrieved data. Alternatively or additionally, the custom PHY 116 or the additional logic can determine when a requested operation can be performed in memory without receiving specific signaling indicating such. Given that some arithmetic can be performed in the memory device using the custom logic 408 without output from the memory device, the custom PHY 116 may not return data in response to every access request. Instead, the custom PHY 116 can return data to the host PHY 108-2 only when an operation is to be performed in the host device 102. The custom PHY 116 and the host PHY 108-2 can thus be configured to enable this selective transmission and reception.

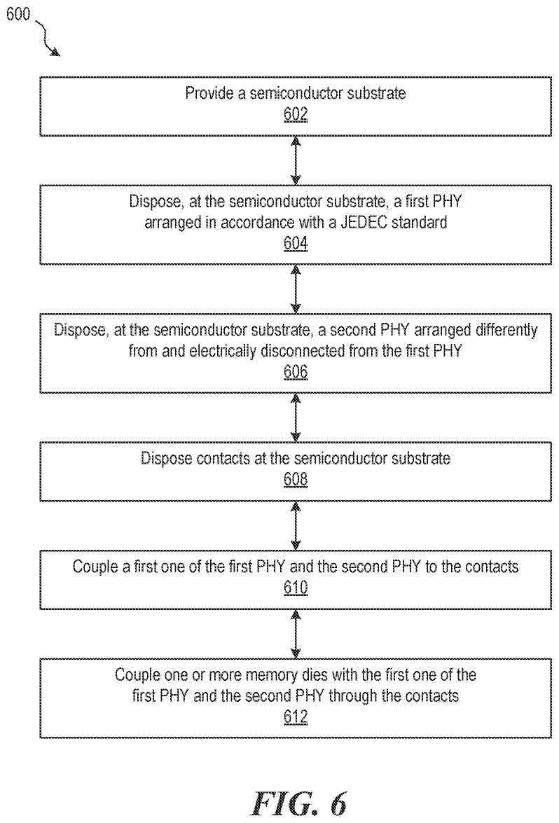

FIG. 6 illustrates an example method 600 for operating a semiconductor device in accordance with an embodiment of the present technology. Although illustrated in a particular configuration, one or more operations of the method 600 may be omitted, repeated, or reorganized. Additionally, the method 600 may include other operations not illustrated in FIG. 6, for example, operations detailed in one or more other methods described herein. The operations described herein may be implemented in hardware, software executed by a processor, firmware, or any combination thereof.

At 602, a semiconductor substrate is provided. The semiconductor substrate can be a die-level or wafer-level substrate. The semiconductor substrate can be used to implement an interface die of a memory device. The semiconductor substrate can include silicon, germanium, silicon-germanium alloy, gallium arsenide, gallium nitride, etc. In some cases, the substrate can be a silicon-on-insulator (SOI) substrate, such as silicon-on-glass (SOG) or silicon-on-sapphire (SOS), or epitaxial layers of semiconductor materials on another substrate. The conductivity of the substrate, or subregions of the substrate, can be controlled through doping using various chemical species including, but not limited to, phosphorus, boron, or arsenic. Doping can be performed during the initial formation or growth of the substrate, by ion-implantation, or by any other doping means.

At 604, a first collection of circuitry is disposed at the semiconductor substrate. The first collection of circuitry comprises a first PHY arranged in accordance with a JEDEC standard. As a specific example, the JEDEC standard can be a JEDEC HBM standard, such as HBM2, HBM3, and so on. The first collection of circuitry can be formed using conventional semiconductor-manufacturing techniques. Materials can be deposited, for example, using chemical vapor deposition, physical vapor deposition, atomic layer deposition, plating, electroless plating, spin coating, and/or other suitable techniques. Similarly, materials can be removed, for example, using plasma etching, wet etching, chemical mechanical, or other suitable techniques.

At 606, a second collection of circuitry is disposed at the semiconductor substrate. The second collection of circuitry comprises a second PHY arranged differently from the first PHY and electrically disconnected from the first PHY. The second collection of circuitry can similarly be formed using conventional semiconductor-manufacturing techniques. In some embodiments, the first collection of circuitry and the second collection of circuitry can be disposed on opposite ends of the semiconductor substrate.

At 608, contacts are disposed at the semiconductor substrate. The contacts can include contact pads capable of coupling with circuitry at one or more memory dies stacked onto the semiconductor substrate. In some embodiments, the contacts can be disposed at a middle portion of the semiconductor substrate separating the first collection of circuitry and the second collection of circuitry.

At 610, a first one of the first collection of circuitry and the second collection of circuitry is coupled with the contacts. In aspects, a second one of the first collection of circuitry and the second collection of circuitry is disconnected from the contacts. In some embodiments, at least one first fuse can connect the first collection of circuitry with the contacts, and at least one second fuse can connect the second collection of circuitry with the contacts. Different ones of the fuses can be burned or left intact to configure the memory device. For example, burning the first fuse can configure the memory device into the custom configuration, while burning the second fuse can configure the memory device into the JEDEC configuration.

At 612, one or more memory dies are coupled with the first one of the first collection of circuitry and the second collection of circuitry through the contacts. For example, the one or more memory dies can include a stack of memory dies coupled through TSVs. The TSVs, or contacts coupled through connective circuitry to the TSVs, can be coupled with the contacts disposed at the semiconductor substrate. In doing so, a memory device can be implemented.

The memory device can be attached to an additional substrate (e.g., an interposer, a PCB, and so on) that connects the memory device to a host device. For example, second contacts can be disposed at a side of the semiconductor substrate opposite the first contacts disposed at 608. A host device can be provided that includes a processor coupled with third contacts. An additional substrate can be provided that includes fourth contacts at a first end and fifth contacts at a second end. The additional substrate can further include connective circuitry (e.g., traces, lines, vias, and so on) coupling the fourth and fifth contacts. The host device and the memory device can be attached to the additional substrate at the fourth and fifth contacts. For example, the second contacts can be coupled with the fourth contacts and the third contacts can be coupled with the fifth contacts. In this way, the host device can connect to a connected one of the first collection of circuitry or the second collection of circuitry through the additional substrate.

From the foregoing, it will be appreciated that specific embodiments of the technology have been described herein for purposes of illustration, but well-known structures and functions have not been shown or described in detail to avoid unnecessarily obscuring the description of the embodiments of the technology. To the extent any material incorporated herein by reference conflicts with the present disclosure, the present disclosure controls. Where the context permits, singular or plural terms may also include the plural or singular term, respectively. Moreover, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. Furthermore, as used herein, the phrase “and/or” as in “A and/or B” refers to A alone, B alone, and both A and B. Additionally, the terms “comprising,” “including,” “having,” and “with” are used throughout to mean including at least the recited feature(s) such that any greater number of the same features and/or additional types of other features are not precluded. Further, the terms “generally,” “approximately,” and “about” are used herein to mean within at least 10 percent of a given value or limit. Purely by way of example, an approximate ratio means within 10 percent of the given ratio.

Several implementations of the disclosed technology are described above in reference to the figures. The computing devices on which the described technology may be implemented can include one or more CPUs, memory, input devices (e.g., keyboard and pointing devices), output devices (e.g., display devices), storage devices (e.g., disk drives), and network devices (e.g., network interfaces). The memory and storage devices are computer-readable storage media that can store instructions that implement at least portions of the described technology. In addition, the data structures and message structures can be stored or transmitted via a data transmission medium, such as a signal on a communications link. Thus, computer-readable media can comprise computer-readable storage media (e.g., “non-transitory” media) and computer-readable transmission media.

It will also be appreciated that various modifications may be made without deviating from the disclosure or the technology. One of ordinary skill in the art will understand that various components of the technology can be further divided into subcomponents, or that various components and functions of the technology may be combined and integrated. In addition, certain aspects of the technology described in the context of particular embodiments may also be combined or eliminated in other embodiments.

Furthermore, although advantages associated with certain embodiments of the technology have been described in the context of those embodiments, other embodiments may also exhibit such advantages, and not all embodiments need necessarily exhibit such advantages to fall within the scope of the technology. Accordingly, the disclosure and associated technology can encompass other embodiments not expressly shown or described herein.

From the foregoing, it will be appreciated that specific embodiments of the invention have been described herein for purposes of illustration, but that various modifications may be made without deviating from the scope of the invention. Rather, in the foregoing description, numerous specific details are discussed to provide a thorough and enabling description for embodiments of the present technology. One skilled in the relevant art, however, will recognize that the disclosure can be practiced without one or more of the specific details. In other instances, well-known structures or operations often associated with memory systems and devices are not shown, or are not described in detail, to avoid obscuring other aspects of the technology. In general, it should be understood that various other devices, systems, and methods in addition to those specific embodiments disclosed herein may be within the scope of the present technology.

What is claimed is:

1. A memory device comprising:
a base semiconductor die comprising:
a first collection of circuitry comprising a first physical interface (PHY) arranged in accordance with a Joint Electron Device Engineering Council (JEDEC) standard;
a second collection of circuitry comprising a second PHY arranged differently from the first PHY and electrically disconnected from the first PHY;
first contacts disposed at a first side of the base semiconductor die and coupled with a first one of the first collection of circuitry and the second collection of circuitry; and
second contacts disposed at a second side of the base semiconductor die opposite the first side, the second contacts coupled with the first one of the first collection of circuitry and the second collection of circuitry; and
one or more memory dies coupled with the base semiconductor die through the second contacts.

2. The memory device of claim 1, wherein the base semiconductor die further comprises:
one or more fuses connecting the first one of the first collection of circuitry and the second collection of circuitry with the second contacts; and
one or more burnt fuses disconnecting a second one of the first collection of circuitry and the second collection of circuitry from the second contacts.

3. The memory device of claim 1, wherein the base semiconductor die further comprises:
a middle portion having the second contacts and one or more through-silicon vias coupled with the second contacts;
a first portion comprising the first collection of circuitry; and
a second portion comprising the second collection of circuitry,
wherein the first portion and the second portion are on opposing sides of the middle portion.

4. The memory device of claim 1, wherein the second collection of circuitry further comprises logical circuitry coupled with the second PHY and configured to perform one or more processing in memory (PIM) operations.

5. The memory device of claim 4, wherein the logical circuitry is further configured to receive signaling indicating that the logical circuitry is to perform the one or more PIM operations, wherein performing the one or more PIM operations is responsive to receiving the signaling indicating that the logical circuitry is to perform the one or more PIM operations.

6. The memory device of claim 4, wherein the logical circuitry comprises an artificial intelligence (AI) accelerator.

7. The memory device of claim 1, wherein the second collection of circuitry further comprises logical circuitry coupled with the second PHY and configured to:
schedule a transmission of commands to the one or more memory dies; or
determine an address at which data requested from the memory device is stored in the one or more memory dies.

8. The memory device of claim 1, wherein the memory device comprises a high-bandwidth memory (HBM) device, and the JEDEC standard comprises a JEDEC HBM standard.

9. A method comprising:
providing a semiconductor substrate;
disposing, at the semiconductor substrate, a first collection of circuitry comprising a first physical interface (PHY) arranged in accordance with a Joint Electron Device Engineering Council (JEDEC) standard;
disposing, at the semiconductor substrate, a second collection of circuitry comprising a second PHY arranged differently from the first PHY and electrically disconnected from the first PHY;
disposing contacts at the semiconductor substrate;
coupling a first one of the first collection of circuitry and the second collection of circuitry to the contacts; and
coupling one or more memory dies with the first one of the first collection of circuitry and the second collection of circuitry through the contacts.

10. The method of claim 9, further comprising:
disposing at least one first fuse coupling the first collection of circuitry and the contacts and at least one second fuse coupling the second collection of circuitry and the contacts; and
burning a first one of the at least one first fuse and the at least one second fuse to disconnect a second one of the first collection of circuitry and the second collection of circuitry from the contacts.

11. The method of claim 9, wherein:
the contacts are disposed at a middle portion of the semiconductor substrate; and
the first collection of circuitry and the second collection of circuitry are separated by the middle portion.

12. The method of claim 9, wherein the second collection of circuitry further comprises logical circuitry coupled with the second PHY and configured to perform one or more processing in memory (PIM) operations.

13. The method of claim 12, wherein the logical circuitry is further configured to receive signaling indicating that the logical circuitry is to perform the one or more PIM operations, wherein performing the one or more PIM operations is responsive to receiving the signaling indicating that the logical circuitry is to perform the one or more PIM operations.

14. The method of claim 12, wherein the logical circuitry comprises an artificial intelligence (AI) accelerator.

15. The method of claim 9, wherein the second collection of circuitry further comprises logical circuitry coupled with the second PHY and configured to:
schedule a transmission of commands to the one or more memory dies; or
determine an address at which data requested from the one or more memory dies is stored in the one or more memory dies.

16. The method of claim 9, wherein the JEDEC standard comprises a JEDEC high-bandwidth memory (HBM) standard.

17. The method of claim 9, wherein the contacts are first contacts disposed at a first side of the semiconductor substrate, the method further comprising:
disposing second contacts at a second side of the semiconductor substrate opposite the first side, the second contacts coupled with the first one of the first collection of circuitry and the second collection of circuitry;
providing an additional substrate comprising third contacts at a third side, fourth contacts at the third side, and connective circuitry coupling the third contacts and the fourth contacts;
providing a host device comprising a processor and fifth contacts coupled with the processor; and
coupling the second contacts with the third contacts and the fifth contacts with the fourth contacts.

18. A semiconductor device assembly comprising:
a host device comprising a processor and a first collection of circuitry including a first physical interface (PHY) coupled with the processor;
a memory device comprising:
a second collection of circuitry comprising a second PHY arranged in accordance with a Joint Electron Device Engineering Council (JEDEC) standard;
a third collection of circuitry comprising a third PHY arranged differently from the second PHY and electrically disconnected from the second PHY; and
one or more memory dies coupled with a first one of the second collection of circuitry and the third collection of circuitry; and
a substrate comprising connective circuitry coupling the first collection of circuitry to the first one of the second collection of circuitry and the third collection of circuitry,
wherein the first PHY is disconnected from a second one of the second collection of circuitry and the third collection of circuitry.

19. The semiconductor device assembly of claim 18, wherein the first one of the second collection of circuitry and the third collection of circuitry comprises the second collection of circuitry.

20. The semiconductor device assembly of claim 18, wherein the first one of the second collection of circuitry and the third collection of circuitry comprises the third collection of circuitry.
